(19) United States
(12) Patent Application Publication
(10) Pub. No.: US 2024/0429724 A1
(43) Pub. Date: Dec. 26, 2024

(54) PORTABLE CHARGING HUB

(71) Applicant: DURACELL U.S. OPERATIONS, INC., Wilmington, DE (US)

(72) Inventors: David Emmons, Isle, MN (US); Jordan Bourilkov, Bethany, CT (US)

(21) Appl. No.: 18/748,294

(22) Filed: Jun. 20, 2024

Related U.S. Application Data
(60) Provisional application No. 63/522,046, filed on Jun. 20, 2023.

(51) Int. Cl. H02J 7/00; H02J 7/34

(52) U.S. Cl. CPC H02J 7/0044; H02J 7/0047; H02J 7/342

(57) ABSTRACT

A portable power station includes a housing and a rechargeable battery disposed within the housing. A charging power port is disposed on the exterior of the housing. The charging power port is electrically connected to the rechargeable battery and the charging power port provides an electrical current to the rechargeable battery for recharging the rechargeable battery. A power outlet is disposed on the exterior of the housing. The power outlet is electrically connected to the rechargeable battery. The power outlet provides electrical current from the battery to a rechargeable device electrically connected to the power outlet for the purpose of recharging the rechargeable device. An illuminating device is disposed about a perimeter of the housing, proximate a top of the housing. The illuminating device is configured to emit light from substantially the entire perimeter of the housing.

### FIELD OF THE DISCLOSURE

The disclosure relates to portable charging hubs (also referred to as portable power stations) and more specifically to portable charging hubs that include a lantern-type light, a bottom charging port, a tiltable charging lid, an offset center of gravity, and/or an improved cooling system.

### BACKGROUND

As modern society becomes increasingly more mobile, there is a need for portable charging of electronic devices. Generally, small portable electronic devices can be recharged by a small backup battery. However, such small backup batteries are only capable of providing a few charges of a small portable electronic device. The small backup batteries are not capable of providing power for larger electronic devices, such as laptop computers, televisions, due to their limited charging capacity.

Current portable charging devices use an external power adapter/battery charger or a built-in battery charger that may include a by-directional inverter/charger. Some portable charging devices use charging speeds recommended by the battery manufacturer to prolong life, such as 20 h for Lead-Acid batteries or 5 h for Li-ion batteries. Other portable charging devices feature a fast charge feature ranging from 2 h to 5 min, which provides faster charging at the expense of shorter battery life, more expensive and bulky circuitry, more dissipated heat, and safety challenges. Generally, known portable charging devices overuse the fast charge feature when it is not needed, and/or use a regular charge feature when a fast charge is needed, which can lead to reduced battery life, or excessive charge time.

### SUMMARY OF THE DISCLOSURE

According to a first embodiment, a portable power station includes a housing and a rechargeable battery disposed within the housing. A charging power port is disposed on the exterior of the housing. The charging power port is electrically connected to the rechargeable battery and the charging power port provides an electrical current to the rechargeable battery for recharging the rechargeable battery. A power outlet is disposed on the exterior of the housing. The power outlet is electrically connected to the rechargeable battery. The power outlet provides electrical current from the battery to a rechargeable device electrically connected to the power outlet for the purpose of recharging the rechargeable device. An illuminating device is disposed about a perimeter of the housing, proximate a top of the housing. The illuminating device is configured to emit light from substantially the entire perimeter of the housing.

According to a second embodiment, a portable power station includes a housing and a rechargeable battery disposed within the housing. A charging power port is disposed on the exterior of the housing. The charging port is electrically connected to the rechargeable battery. The charging power port provides an electrical current to the rechargeable battery for recharging the rechargeable battery. A power outlet is disposed on the exterior of the housing. The power outlet is electrically connected to the rechargeable battery. The power outlet provides electrical current from the battery to a rechargeable device electrically connected to the power outlet for the purpose of recharging the rechargeable device. A tiltable magnetic charging lid is pivotably connected to the housing, proximate a top of the housing. The tiltable magnetic charging lid includes a wireless induction charging coil, a magnet, and a charging interface formed by a top surface of the tiltable magnetic charging lid. The tiltable magnetic charging lid is tiltable from zero to greater than 60 degrees, preferably up to at least 105 degrees relative to the top of the housing.

According to a third embodiment, a portable power station includes a housing and a rechargeable battery disposed within the housing. A charging power port is disposed on the exterior of the housing. The charging port is electrically connected to the rechargeable battery. The charging power port provides an electrical current to the rechargeable battery. A power outlet is disposed on the exterior of the housing. The power outlet is electrically connected to the rechargeable battery. The power outlet provides electrical current from the battery to a rechargeable device electrically connected to the power outlet for the purpose of recharging the rechargeable device. A cooling air flow conduit is formed in the housing. The cooling airflow conduit includes an inlet in a bottom of the housing and an outlet proximate a top of the housing.

The foregoing first, second, and third embodiments of a portable power station may further include any one or more of the following optional features, structures, and/or forms.

In some optional forms, a display screen is disposed on the exterior of the housing.

In other optional forms, the power outlet supplies one of AC power and DC power.

In other optional forms, the power outlet comprises a USB outlet.

In other optional forms, a handle is connected to the housing, the handle being located proximate the top of the housing.

In other optional forms, a programmable processor is disposed in the housing, and a wireless communication device is communicatively connected to the programmable processor.

In other optional forms, the programmable processor is operatively connected to the illumination device and the programmable processor alters a light characteristic of the illumination device based on a signal received from the communication device.

In other optional forms, the illumination device is divided into at least two segments and the programmable processor alters a different characteristic of each segment.

In other optional forms, the light characteristic is one of color, intensity, length, or duration, or combinations thereof.

In other optional forms, the programmable processor alters the light characteristic based on a warning signal from the communication device.

In other optional forms, the warning signal comprises one of a power grid warning, a social alert, or a weather alert, or combinations thereof.

In other optional forms, the programmable processor alters the light characteristic based on an internal condition.

In other optional forms, a brightness control button is disposed on the exterior of the housing, the brightness control button being operatively connected to the illumination device, and the illumination device being adapted to change brightness level with repeated activations of the brightness control button.

In other optional forms, the brightness control button converts to an on/off button for the illumination device if a minimum period of time passes between activations of the brightness control button.

In other optional forms, the minimum period of time is greater than or equal to 5 seconds.

In other optional forms, the illumination device comprises a RGB LED.

In other optional forms, the magnet is disposed in an opening in the tiltable magnetic charging lid.

In other optional forms, the tiltable magnetic charging lid further comprises a thin plastic cover that is the only separation between the magnet and the charging interface.

In other optional forms, the plastic cover includes a silicone coating.

In other optional forms, the tiltable magnetic charging lid comprises a top surface having a central raised platform.

In other optional forms, the opening is annular in shape and the opening is located at least partially in the central raised platform.

In other optional forms, the magnet and plastic cover form a raised annular ring on the central raised platform that extends outward from a top surface of the lid.

In other optional forms, the lid comprises a recessed annular portion outward of the central raised platform, the recessed annular portion being recessed relative to the central raised platform and the recessed annular portion at least partially surrounds the magnet and plastic cover.

In other optional forms, a recessed storage compartment is disposed in a top of the housing, the recessed storage compartment being recessed relative to the top of the housing, the tiltable magnetic charging lid covering the recessed storage compartment when the tiltable magnetic charging lid is in a closed position, and the tiltable magnetic charging lid exposing at least a part of the recessed storage compartment when the tiltable magnetic charging lid is not in the closed position.

In other optional forms, the power outlet is disposed on a front portion of the housing, and the housing includes a longitudinal axis, the longitudinal axis being located between the rechargeable battery and the power outlet.

In other optional forms, the tiltable magnetic charging lid is pivotably attached to the housing with a hinge, and the hinge is attached to the housing in at a front portion of the housing, such that the longitudinal axis is disposed between the hinge and the rechargeable battery.

In other optional forms, comprising a metal mesh covers the outlet of the cooling airflow conduit.

In other optional forms, at least one raised channel is disposed in the bottom of the housing, the raised channel being configured to allow air to flow radially inward along a bottom of the housing when the housing is resting on a flat surface.

In other optional forms, a variable speed fan is fluidly connected to the cooling airflow conduit, the variable speed fan being configured to move air through the cooling airflow conduit from the inlet to the outlet.

In other optional forms, a quick charge switch is operatively connected to the power outlet and to the variable speed fan, the quick charge switch being configured to change the power output of the power outlet to a quick charge level and the quick charge switch also operating the fan when the power outlet is changed to the quick charge level.

In other optional forms, the quick charge switch operates the power outlet at the quick charge level for a period of time, or until a device being charged reaches a full charge state, and, thereafter, the power outlet returns to a normal charge level and the variable speed fan is turned off.

In other optional forms, a current limiter is operatively connected to a DC input, the current limiter limiting current based an input voltage.

In other optional forms, the current limiter limits current to less than 10 A when the input voltage is below 16 VDC.

In other optional forms, the current limiter limits current to between about 20 A and about 30 A when the voltage is above 16 VDC.

In other optional forms, a speaker and a microphone are operatively attached to the housing, and the speaker and the microphone are communicatively connected to a programmable processor and communication device.

In other optional forms, the charging port is disposed on the bottom of the housing.

In other optional forms, the charging port is disposed on a side wall of the housing.

In other optional forms, the charging port is a first charging port disposed on the bottom of the housing, and further comprising a second charging port disposed on a side wall of the housing.

In other optional forms, the charging port is disposed on the bottom of the housing and the charging port is omnidirectional and is adapted to contact electrical contacts of a charging base regardless of rotational orientation between the portable power station and the charging base.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is a top-front perspective view of a first embodiment of a portable power station.

FIG. 2 is a front view of the portable power station of FIG. 1.

FIG. 3 is a back view of the portable power station of FIG. 1.

FIG. 4 is a left side view of the portable power station of FIG. 1.

FIG. 5 is a right side view of the portable power station of FIG. 1.

FIG. 6 is a top view of the portable power station of FIG. 1.

FIG. 7 is a bottom view of the portable power station of FIG. 1.

FIG. 8A is an exploded perspective view of the portable power station of FIG. 1.

FIG. 8B is a perspective cross-sectional view of the portable power station of FIG. 1.

FIG. 9 is a top cross-sectional view of the portable power station of FIG. 1.

FIG. 10A is a top perspective view of a power supply sub-assembly of the portable power station of FIG. 1.

FIG. 10B is a side perspective view of the power supply sub-assembly of FIG. 10A.

FIG. 11 is a close up cross-sectional view of a lid of the portable power station of FIG. 1.

FIG. 12 is a top perspective view of a top end of the portable power station of FIG. 1, with a lid in an open position.

FIG. 13 is a top-front perspective view of a second embodiment of a portable power station.

FIG. 14 is a front view of the portable power station of FIG. 13.

FIG. 15 is a back view of the portable power station of FIG. 13.

FIG. 16 is a left side view of the portable power station of FIG. 13.

FIG. 17 is a right side view of the portable power station of FIG. 13.

FIG. 18 is a top view of the portable power station of FIG. 13.

FIG. 19 is a bottom view of the portable power station of FIG. 13.

FIG. 20A is an exploded perspective view of the portable power station of FIG. 13.

FIG. 20B is a perspective cross-sectional view of the portable power station of FIG. 13.

FIG. 21 is a top perspective cross-sectional view of the portable power station of FIG. 13.

FIG. 22 is a front-perspective cross-sectional view of the portable power station of FIG. 13.

FIG. 23 is a side cross-sectional view of the portable power station of FIG. 13.

FIG. 24A is a top perspective view of a power supply sub-assembly of the portable power station of FIG. 13.

FIG. 24B is a side perspective view of the power supply sub-assembly of FIG. 24A.

FIG. 25 is a front-top perspective view of a third embodiment of a portable power station.

FIG. 26A is another front perspective view of the power supply station of FIG. 25.

FIG. 26B is a rear perspective view of the power supply station of FIG. 25.

FIG. 26C is a close up view of a recharge port of the power supply station of FIG. 25.

FIG. 27 is a front view of the portable power station of FIG. 25.

FIG. 28 is a back view of the portable power station of FIG. 25.

FIG. 29 is a left side view of the portable power station of FIG. 25.

FIG. 30 is a right side view of the portable power station of FIG. 25.

FIG. 31 is a top view of the portable power station of FIG. 25.

FIG. 32 is a bottom view of the portable power station of FIG. 25.

FIG. 33 is front view of the portable power station of FIG. 25 with the housing removed.

FIG. 33 is a rear view of the portable power station of FIG. 25 with the housing removed.

FIG. 34 is a side perspective cross-sectional view of the portable power station of FIG. 25.

### DETAILED DESCRIPTION

Unless specifically stated otherwise, any feature, structural element, or function of one described embodiment may be combined with the features, structural elements, or functions of any other embodiment described in the specification.

As used herein, “portable charging hub” and “portable power station” are used interchangeably.

The rechargeable batteries in the portable charging hubs and portable power stations described herein typically have a Watt rating (W) of between 100 W and 1000 W or between 350 W and 1000 W, and an energy capacity in Watt hours (Wh) of between 50 and 1050 Wh, between 200 and 1050 Wh, between 75 and 850 Wh, between 90 and 700 Whr, between 200 and 700 Wh, or between 210 and 620 Wh. The rechargeable batteries should have the capacity to charge an iPhone® 14 (12.68 Wh capacity) between 4 and 60 times, charge a Samsung® ng S23 phone (15.05 Wh capacity) between 3 and 55 times, charge an iPad® mini tablet generation 6 (19.3 Wh capacity) between 3 and 40 times, charge a Macbook® air (49.9 Wh capacity) between 1 and 16 times, and charge a DJI® mini 3 drone (18.1 Wh capacity) between 3 and 42 times. The rechargeable batteries should have the capacity to run a wifi router (20 Watt power consumption) for between 7 and 40 hours, run a CPAP machine (45 Watt power consumption) between 4 and 10 hours, run a travel CPAP machine (12.5 Watt power consumption) between 12 and 62 hours, run a mini cooler (17.5 Watt power consumption) between 9 and 44 hours, run a mini refrigerator (on a 50% duty cycle at 25 Watt power consumption) between 6 and 32 hours, run a fan (45 Watt power consumption) between 3 and 32 hours, run a television (75 Watt power consumption) between 3 and 17 hours, run an Xbox® (100 Watt power consumption) between 1.6 and 8 hours, run a slow cooker (125 Watt power consumption) between 1 and 6 hours, run a Magic Bullet® blender (250 Watt power consumption) between 0.5 and 3.0 hours, and run a refrigerator (25% duty cycle at 60 Watt power consumption) between 3 and 13 hours. Power supplies in these ranges advantageously have the capacity to run virtually any household electrical appliance while remaining small and light enough for portability.

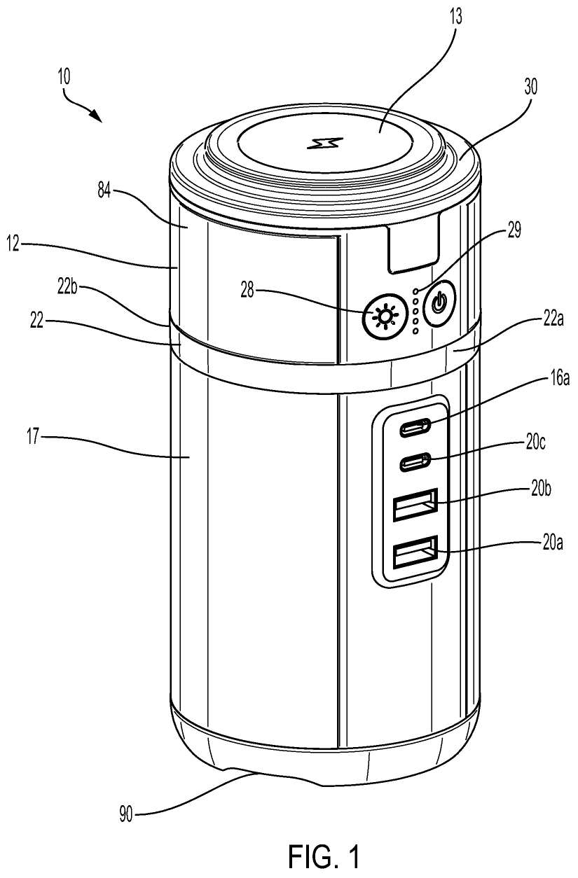

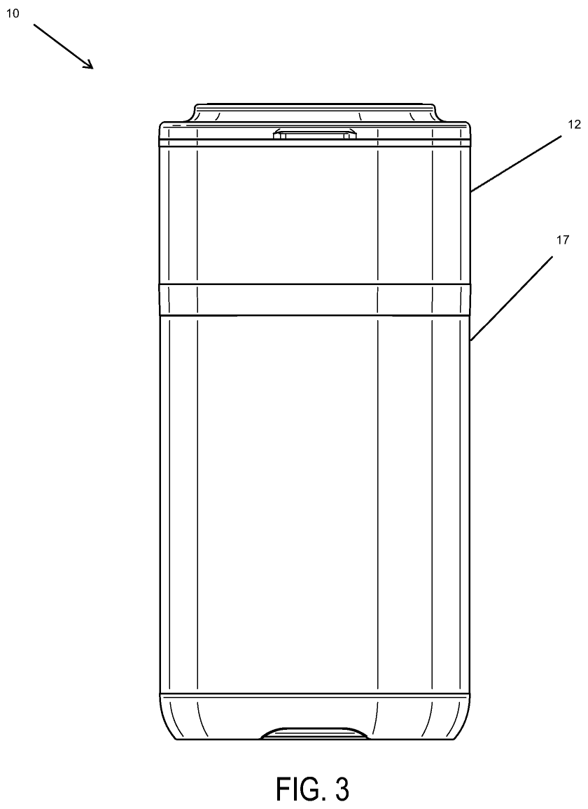

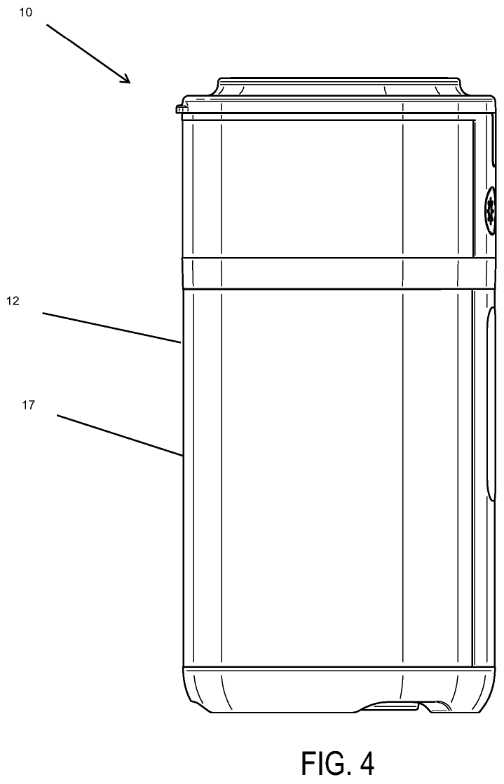

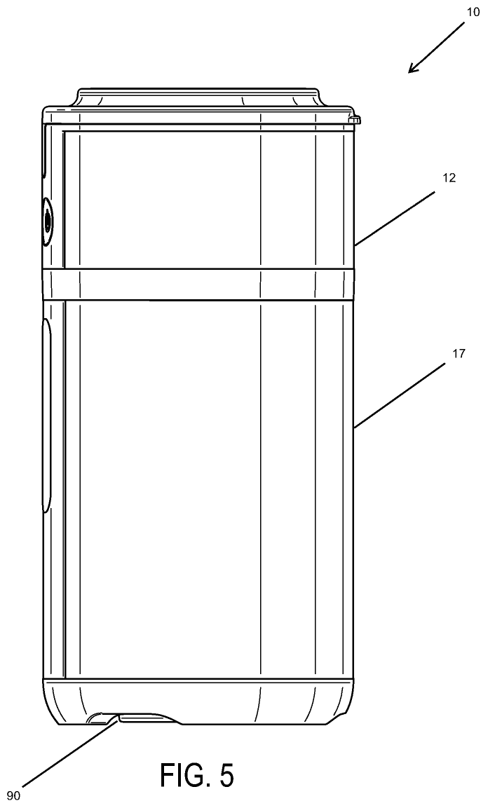

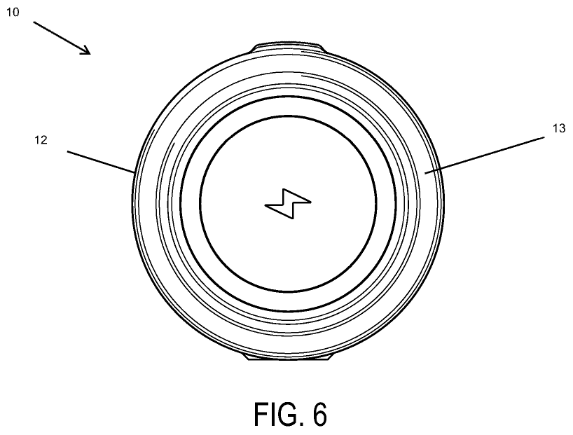

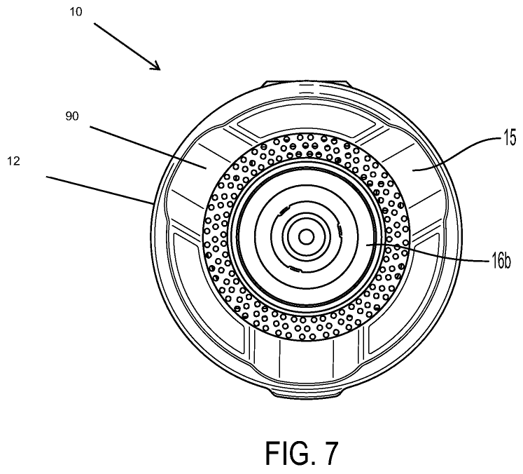

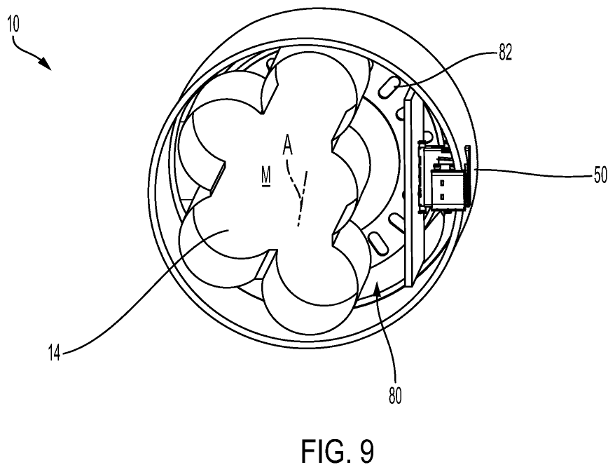

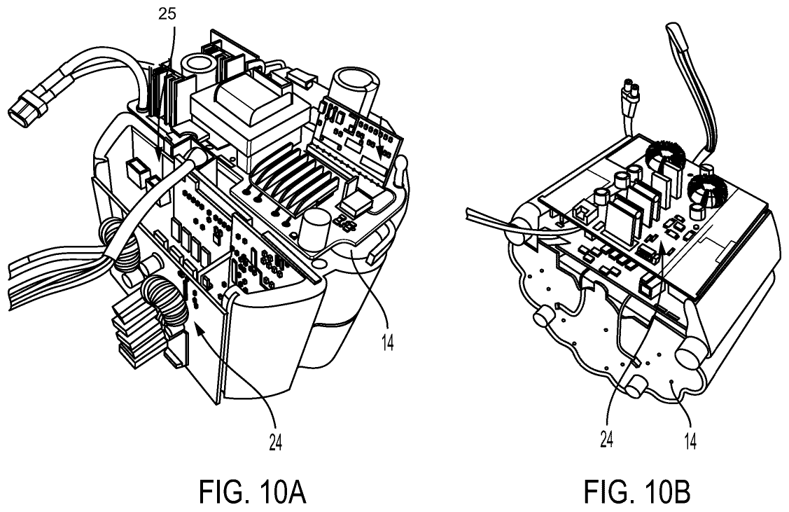

Turning now to FIGS. 1-12, a first embodiment of a portable charging hub or a portable power station 10 includes a housing 12 and a rechargeable battery 14 disposed within the housing 12. The portable power station 10 provides portable power for electronic devices when no other source of power is available. For example, in a remote environment, such as camping, the portable power station 10 provides power to do one or more of the following: recharge portable electronic devices, such as cell phones or tablet computers, run or recharge laptop computers, run a television, run a WiFi network, run a kitchen appliance, such as a blender, run lights, or run other electronic equipment.

In the embodiment illustrated in FIGS. 1-12, the housing 12 is cylindrical in shape (having a circular cross-sectional shape) and includes a top 13, a bottom 15, and a side wall 17. In other embodiments, the housing 12 may have other cross-sectional shapes, such as oval, oblong, square, rectangular, triangular, polygonal, or irregular. In some embodiments, the cylindrical housing 12 may have between a 2.0 inch and a 4.5 inch diameter, preferably between 2.5 inch and 4.0 inch diameter, and more preferably between 2.75 inch and 3.5 inch diameter. Diameters in these ranges advantageously allow the housing 12 to be placed and secured in a cup holder, for example in the cup holder of a car or other vehicle. Moreover, diameters in these ranges provide a stable platform when the portable power station 10 is placed on a support surface, such as a table or the ground. Furthermore, diameters in these ranges produce a relatively small footprint for the portable power station, which minimizes shelf or counter space lost to the portable power station.

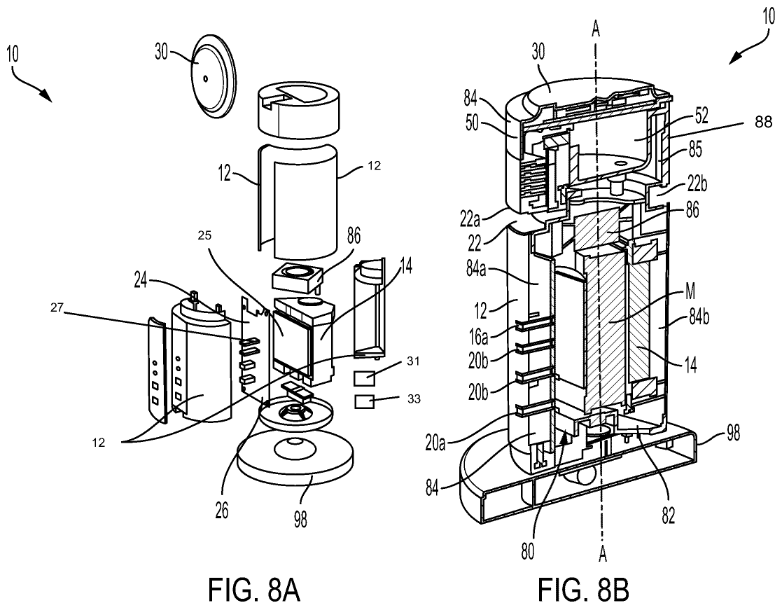

One or more charging power ports 16a, 16b may be disposed on the exterior of the housing 12. The charging power ports 16a, 16b are electrically connected to the rechargeable battery 14 and the charging power ports 16a, 16b provide an electrical current to the rechargeable battery 14 for recharging the rechargeable battery 14 of the portable power station 10. In the illustrated embodiment, a first charging power port 16a may comprise a two way power port, such as a USB-c port. The first charging power port 16a in the embodiment illustrated in FIGS. 1-12 is located on the side wall 17 of the housing and may accept power to charge the rechargeable battery 14 or may provide power from the rechargeable battery 14 to a device connected to the charging power port 16a. Additionally, or alternatively, a second charging power port 16b comprises a circular charging port, such as an induction power port, located on the bottom 15 of the housing 12. In other embodiments, the second charging power port 16b may comprise electrical contacts that receive power from a charging base. Regardless, the second charging port 16b located on the bottom 15 of the housing 12 is omnidirectional. More specifically, the second charging port 16b may connect with a charging device, such as the charging plate 98 in FIG. 8B, in any rotational orientation (i.e., any 360 degree rotational position) between the charging device and the housing 12. In yet other embodiments, the charging power ports 16a, 16b may be located on another part of the housing, for example on the side wall 17 or on the top 13. In still other embodiments, the first charging power port 16a may comprise a two or three prong plug (not shown) for a power cord (not shown). Power for the charging power ports 16a, 16b may be provided by virtually any power source, such as an induction charger connected to a power grid, a DC power source connected to the charging power port 16 by a plug or wire, for example, a DC power source from a vehicle or a DC power source from a portable solar panel, or an AC source, such as a power cord connected to a residential or industrial power grid.

One or more power outlets 20a, 20b, 20c are disposed on the exterior of the housing 12. In the embodiment illustrated in FIGS. 1-12, the power outlets 20a, 20b, 20c, are located on the side wall 17 of the housing. In other embodiments, the power outlets 20a, 20b, 20c, may be located on other parts of the housing as long as the power outlets 20a, 20b, 20c are accessible to a user, for example, the power outlets 20a, 20b, 20c, may be located on the top 13 of the housing. The power outlets 20a, 20b, 20c are electrically connected to the rechargeable battery 14. The power outlets provide electrical current from the rechargeable battery 14 to a rechargeable device or electrical device (not shown), such as a cellular phone, a tablet, a laptop, a television, a light, a WiFi router, etc., that is electrically connected to the power outlet 20a, 20b, 20c for the purpose of recharging the rechargeable device or for providing electricity to the electrical device. The power outlets 20a, 20b, 20c may supply AC power or DC power. Moreover, the power outlets 20a, 20b, 20c may comprise a plug receptacle, such as a USB-C receptacle or a USB-A receptacle. Other types of plug receptacles may be used in other embodiments, such as a three-prong receptacle, a two-prong receptacle, a mini USB-B receptacle, or a micro USB-B receptacle.

Some known portable power stations include a directional light, such as a flashlight. More specifically, the lights included on known portable power stations are highly directional in nature and emit from either a single spot or from a single face of a housing that is common with the power outlet. Thus, the lights on known portable power stations do not illuminate the power outlet itself, but rather project light outward from the housing. Thus, lights on known portable power stations do not help in connecting an electronic device to the power outlet in low light conditions.

Contrary to known power stations, the disclosed portable power station 10 includes an illuminating device 22, such as a ring or circumferential light, disposed about a perimeter of the housing 12, proximate the top 13 of the housing 12. In other embodiments, the illuminating device 22 may be located proximate the bottom 15 of the housing. For cylindrical housings 12, the illuminating device 22 projects from substantially 360 degrees around the housing 12. Said another way, the illuminating device 22 is configured to emit light from substantially the entire perimeter of the housing 12. In the illustrated embodiment, the illuminating device is annular or ring-shaped and forms a ring around the cylindrical housing 12. The annular or ring-shaped illuminating device 22 is particularly useful in that the illuminating device 22 provides a lantern-like effect by emitting light in multiple directions from the housing 12. Moreover, the illuminating device may have a diffusing cover that emits a diffuse light, rather than a focused light to further enhance the lantern-like effect. This lantern-like effect advantageously illuminates not only the area around the portable power station, but also illuminates the power outlets 20a, 20b, 20c, which facilitates locating and connecting the electronic device to the power outlets 20a, 20b, 20c.

In some embodiments, the illuminating device 22 may comprise a plurality of discrete light emitting elements, such as light emitting diodes (LED), disposed about a perimeter of the housing 12. The plurality of LEDs may all be a single color, or the plurality of LEDs may comprise RGB LEDs to create different colors. In certain embodiments, the light emitting device 22 may emit light from substantially 360 degrees around the housing 12 (with the exception of small breaks for other elements, such as a handle). In some embodiments, the illumination device 22 may be divided into at least two segments, such as a front segment 22a and a rear segment 22b. In other embodiments, the illumination device 22 may be divided into a plurality of segments, such as 3, 4, 5, 6, or more segments. In the illustrated embodiment, the front segment 22a and the rear segment 22b may be independently controllable by a programmable processor 24. In other embodiments, one or more of the plurality of segments may be independently controllable.

Turning now specifically to FIGS. 8A and 8B, the programmable processor 24 is disposed in the housing 12, and a wireless communication device 26 is communicatively connected to the programmable processor 24. The programmable processor 24 may also be operatively connected to a battery management system 25. The communication device 26 may comprise an antenna and a signal receiver. The communication device 26 may be configured to connect to other devices with Bluetooth® or WiFi signals, or any other type of wired or wireless communication protocol. The programmable processor 24 is operatively connected to the illumination device 22 and the programmable processor 24 alters a light characteristic of the illumination device 22 based on a signal received from the communication device 26. The programmable processor 24 is configured to alter a different characteristic of each segment. In some embodiments, the light characteristic is one of color, intensity, length, or duration, or combinations thereof. The programmable processor 24 alters the light characteristic based on a warning signal from the communication device 26. The warning signal may comprise one of a power grid warning (e.g., a power grid failure warning), a social alert, or a weather alert (e.g., a severe thunderstorm alert, a tornado watch, a tornado warning, a flash flood warning, a heat advisory, a hurricane watch, a hurricane warning, or any other weather related warning or notice), or combinations thereof. In other embodiments, the programmable processor 24 may be configured to alter the light characteristic based on an internal condition or an external condition, such as battery temperature (hot or cold) or battery charge capacity, overloads, low ambient light, g-loads (such as when the device is dropped), or other conditions. The programmable processor 24 may receive signals directed to such conditions from a sensor suite 27 located in the housing 12. The sensor suite may include temperature sensors, acceleration sensor, glass break sensors, humidity sensors, ambient light sensors, occupancy sensor or other sensors. Additionally, the illumination device 22 may be programmed through an app or other communication device to schedule on/off operations for, for example, security, wake up lights, phone calls, Bluetooth or wifi connections, find a phone apps, etc. Alternatively, the programmable processor 24 may control the illumination device 22 to change light characteristics in response to music or other media received through the communication device 26.

A brightness control button 28 is disposed on the exterior of the housing 12. The brightness control button 28 is operatively connected to the illumination device 22. The brightness control button 28 is configured to change a brightness level of the illumination device 22 with repeated activations of the brightness control button 28. In some embodiments, the brightness control button 28 converts to an on/off button for the illumination device 22 if a minimum period of time passes between activations of the brightness control button 28. For example, the brightness control button 28 may convert to an on/off button if a minimum period of time is greater than or equal to 5 seconds. In other embodiments, the minimum period of time may be between 1 second and 30 seconds, between 5 seconds and 20 seconds, or between 10 seconds and 20 seconds. A series of indicator lights 29 may be disposed on the housing 12. The indicator lights 29 may indicate the intensity of the illumination device 22. For example, one indicator light may indicate 20% intensity. Other indicator lights 29 may indicate increasing intensity, for example, in 20% increments. In other embodiments, more or fewer indicator lights 29 may be included, which indicate greater or less than 20% increments.

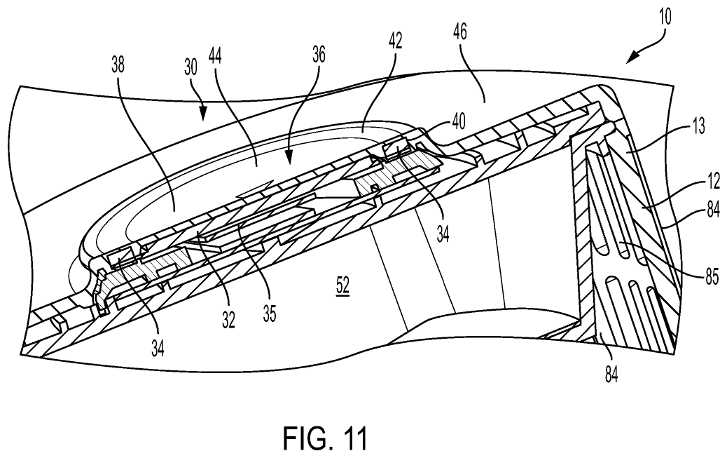

Turning now to FIG. 11, a tiltable magnetic charging lid 30 is pivotably connected to the housing 12, proximate the top 13 of the housing 12. The tiltable magnetic charging lid 30 includes a wireless induction charging coil 32, a magnet 34, and a charging interface 36 formed by a top surface 38 of the tiltable magnetic charging lid 30. The tiltable magnetic charging lid 30 is tiltable from zero to greater than 70 degrees, more preferably greater than 90 degrees and even more preferably up to at least 180 degrees relative to the top 13 of the housing 12. By tilting in these ranges, a mobile phone or tablet computer is able to record a wide area (both vertically and horizontally), which is particularly useful when the portable power station 10 is located at the same level, or higher than the subject of the recording. In other words, by tilting to greater than 70 degrees, greater than 90 degrees, and up to 180 degrees, a mobile phone or tablet computer magnetically attached to the tiltable magnetic charging lid 30 is capable of recording subjects that require a downward viewing angle. Current magnetic charging surfaces are typically relatively flat so that the mobile phone or tablet computer does not slide off the charging surface.

In order to reduce sliding of the mobile phone or tablet computer on the tiltable magnetic lid 30 when the tilt angle exceeds about 70 degrees, the magnet 34 produces a significant magnetic attraction towards the top surface 30. The magnet 34 is disposed in an opening 40 in the tiltable magnetic charging lid 30. In the illustrated embodiment, the opening 40 is annular in shape. The opening 40 may be continuous forming an annular opening in the tiltable magnetic charging lid 30. In other embodiments, the opening 40 may have other shapes, such as discontinuous annular shapes, or other shapes, such as straight, or curved shapes. The tiltable magnetic charging lid 30 further comprises a thin plastic cover 42 that is the only separation between the magnet 34 and the charging interface 36. By reducing the distance between the charging surface 36 and the magnet 34, the magnetic force produced by the magnet 34 is greater at the charging surface, than would otherwise happen if the separation were larger. In some embodiments, the plastic cover 42 may comprise a thermoplastic elastomer or rubber having a higher coefficient of friction than the top of the lid 30. In other embodiments, the plastic cover 42 may comprise a silicone coating. The thermoplastic elastomer, rubber, or silicone coating increases friction between the charging surface 36 and the mobile phone or tablet computer, which further reduces slipping when the charging surface 36 is tilted. A ferrite plate 35 is located below the magnet 34. The ferrite plate 35 enhances and directs the magnetic field generated by the magnet 34 towards the charging interface 36, which creates a stronger magnetic bond with an object, such as a mobile phone or tablet computer, that is magnetically attracted to the charging interface.

The top surface 38 has a central raised platform 44. The central raised platform 44 forms a support or interface surface for a rechargeable device, such as the mobile phone or tablet computer (not shown). The rechargeable device is supported by the central raised platform 44 when the rechargeable device is magnetically removably attached to the tiltable magnetic charging lid 30. The opening 40 is located at least partially in the central raised platform 44. The magnet 34 and the plastic cover 42 form a raised annular ring on the central raised platform 44 that extends outward from the top surface 38 of the tiltable magnetic charging lid 30. The raised annular ring further reduces slipping when the charging surface 36 is tilted.

The tiltable magnetic charging lid 30 comprises a recessed annular portion 46 outward of the central raised platform 44. The recessed annular portion 46 is recessed relative to the central raised platform 44 and the recessed annular portion 46 at least partially surrounds the magnet 34 and the plastic cover 42. The recessed annular portion 46 concentrates friction on the central raised platform 44, further reducing slipping.

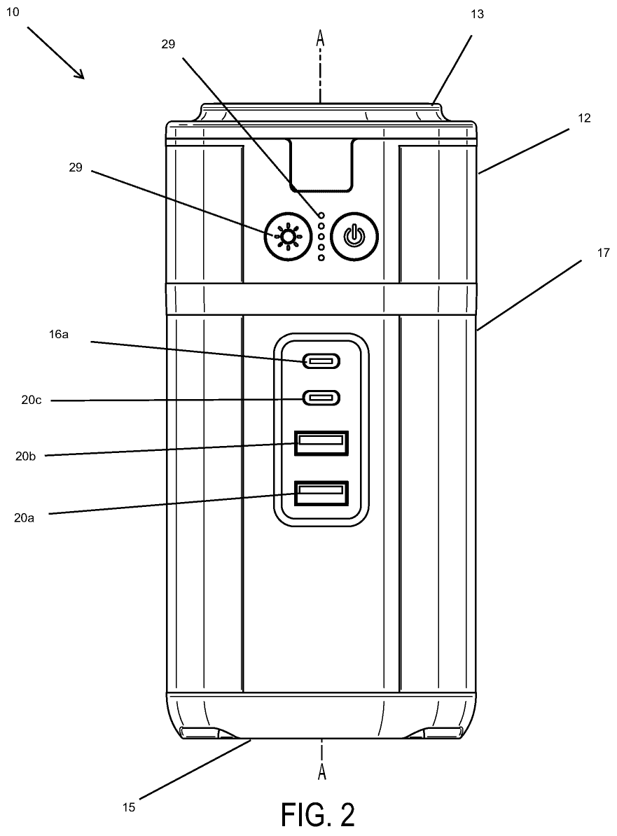

When the tiltable magnetic charging lid 30 has a charging device (such as a mobile phone) attached thereto and the tiltable magnetic charging lid 30 is tilted to greater than about 70 degrees, a tipping moment generated by the weight of the charging device is created that could cause the personal power station 10 to tip over. To correct this problem, the personal power station 10 includes a center of gravity offset configuration to counter the tipping moment, which keeps the center of gravity within the footprint of the bottom 15 of the housing 12, thereby preventing the personal power station 10 from tipping over. More specifically, in the embodiment of FIGS. 1-12, the power outlets 20a, 20b, 20c are disposed on a front portion of the housing 12. The housing 12 includes a longitudinal axis A (see FIGS. 2 and 8B), the longitudinal axis A being located between a center of mass M of the rechargeable battery 14 and the power outlets 20a, 20b, 20c. In one embodiment, the distance between the longitudinal axis A and the center of mass M is between 5% and 50% of the distance between the longitudinal axis A and the outer edge of the housing 12 (i.e., between 5% and 50% of the radius of the cylindrical housing 12. The distance between the longitudinal axis A and the center of mass M produces a tipping moment in the opposite direction of, and that counters, the tipping moment created by the tiltable magnetic charging lid 30 and an electronic device (such as a cell phone) magnetically connected thereto when the tiltable magnetic charging lid 30 is in an open position (and particularly when the tiltable magnetic charging lid is opened 70 degrees or more). In other words, the center of mass M of the rechargeable battery 14 is purposefully offset from the longitudinal axis A in the opposite direction of a hinge of the tiltable magnetic charging lid 30. In some embodiments, the lowest power outlet 20a, 20b, 20c is located at least 1 inch above the bottom 13 of the housing 12, preferably at least 1.5 inches above the bottom 13 of the housing 12, and more preferably at least 3 inches above the bottom 15 of the housing 12. By raising the power outlets at least one inch above the bottom 15 of the housing, room is left for an internal cooling circuit, which is discussed further below.

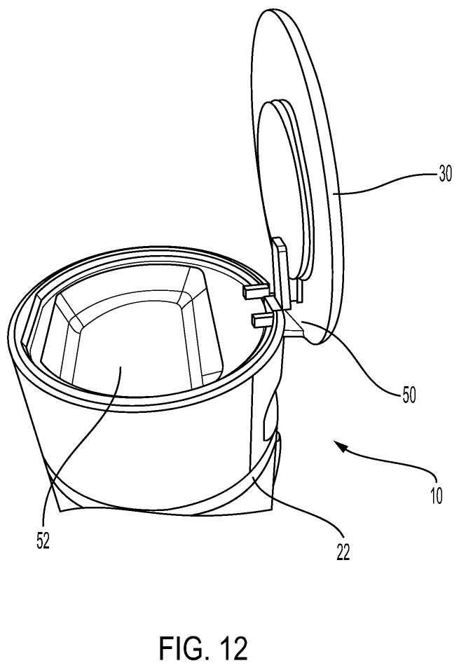

The tiltable magnetic charging lid 30 is pivotably attached to the housing 12 with a hinge 50 (FIGS. 8B and 12). As discussed above, in order to oppose the tipping moment caused when the tiltable magnetic charging lid 30 is open, the hinge 50 is attached to the housing 12 at a front portion of the housing 12, proximate the power outlets 20a, 20b, 20c, such that the longitudinal axis A is disposed between the hinge 50 and the center of mass M of the rechargeable battery 14. In other embodiments, the hinge 50 may be positioned at other locations along the perimeter of the housing 12, and center of mass M of the rechargeable battery 14 is then positioned on the opposite side of the longitudinal axis A from the hinge 50 such that the longitudinal axis A is located between the center of mass M of the rechargeable battery 14 and the hinge 50.

An optional speaker 31 and microphone 33 may be incorporated into the housing 12. The speaker 31 and the microphone 33 may be operatively connected to the programmable processor 24. The programmable processor 24 may use the communication device 26 to provide intercom and 2-way communication between the portable power station 10 and a mobile communication device, such as a mobile phone.

A recessed storage compartment 52 (FIGS. 8B, 11, and 12) is disposed in the top 13 of the housing 12. The recessed storage compartment 52 is recessed relative to the top 13 of the housing 12. The recessed storage compartment 52 is adapted to store items, such as charging cords, ear buds, wallets, jewelry, etc. The tiltable magnetic charging lid 30 covers the recessed storage compartment 52 when the tiltable magnetic charging lid 30 is in a closed position (FIGS. 1-6, 8B, and 11). The tiltable magnetic charging lid 30 exposes at least a part of the recessed storage compartment 52 when the tiltable magnetic charging lid 30 is not in the closed position (FIG. 12).

Most known portable power stations rely on large fans to move cooing air over internal electronic components. These large fans are energy hungry and are usually quite noisy. Additionally, known portable power stations typically minimize unused space in a housing to reduce the overall size of the device and thus place the rechargeable battery as close to the housing wall as possible, thereby exposing only some of the rechargeable battery to cooling airflow.

The housing 12 of the disclosed portable power station 10 includes a cooling channel 80 (FIG. 8B) for cooling internal components, such as the rechargeable battery 14, the programmable processor 24 and the communication device 26. The cooling channel 80 is formed by an air inlet 82 formed in the bottom of the housing 12, a cooling conduit 84 that extends along a length of the housing 12, inside the housing sidewall 17, and an air outlet 85, proximate the top 13 of the housing 12. The rechargeable battery 14 is elevated (or spaced apart from) the bottom 15 of the housing, which creates additional cooling surface area that is exposed to the cooling conduit 84. The rechargeable battery 14 is elevated from the bottom of the housing 15 by at least 0.5 in, preferably at least 1 in, and more preferably at least 1.5 in. Elevations in these ranges provide excellent cooling airflow that enhances cooling of the rechargeable battery 14.

The cooling conduit 84 may comprise two or more cooling branches 84a, 84b. A first cooling branch 84a passes around parts of the rechargeable battery 14 to cool the rechargeable battery 14. A second cooling branch 84b bypasses the rechargeable battery 14 and extends upward to pass around the programmable processor 24 and other electronics. By separating the electronics from the rechargeable battery 14, heat from the rechargeable battery 14 is not transferred to the electronics, which could cause electronic overheating. A fan 86 is located within the cooling conduit 84, generally above the rechargeable battery 14 and the electronic components, such as the programmable processor 24. The fan 86 is a variable speed fan that is operatively connected to the programmable processor 24. The fan 86 aids in moving air through the cooling conduit 84 when extra cooling capacity is needed. However, the air inlet 82 being located in the bottom 15 of the housing 12 and the air outlet 85 being located proximate the top 13 of the housing creates a convective airflow due to the rising hot air inside the housing 12. The convective airflow reduces the need for the fan 86 to augment the cooling airflow through the cooling conduit 84, thereby saving energy and reducing unwanted noise. As a result, a smaller fan may be used. A metal mesh 88 covers the air outlet 85 of the cooling conduit 82. In some embodiments, the openings in the metal mesh 88 may be designed to enhance airflow out of the air outlet 85, thereby increasing cooling airflow through the cooling conduit 84. In some embodiments, the metal mesh 88 may comprise 10% to 50% of the height of the housing 12, preferably 20% to 40% of the height of the housing, and more preferably between 30% and 36% of the height of the housing.

The portable power station 10 is normally placed in an upright position on a flat surface, such as a charging plate 98 (FIG. 8B), or other flat surface such as a table, a desk, or the ground. The charging plate 98 and the second charging port 16b on the bottom 15 of the housing 12 may connect in any relative rotational orientation about a vertical axis to produce a charging coupling between the charging plate 98 and the second charging port 16b. A plurality of raised channels 90 is disposed in the bottom 15 of the housing 12. The raised channels 90 are configured to allow air to flow radially inward along the bottom 15 of the housing 12 when the housing 12 is resting on a flat surface so that air can enter the air inlet 82. The plurality of raised channels 90 preferably includes between two and six raised channels 90, more preferably between 3 and 5 raised channels, and even more preferably between 3 and 4 raised channels. This number of raised channels 90 allows for excellent air flow volume while leaving sufficient bottom surface to stabilize the portable power station 10. Moreover, the shape of the raised channels 90 focuses and accelerates air flowing into the air inlet 82, by narrowing slightly from the outer perimeter of the housing 12 towards the center of the bottom of the housing, which further enhances cooling.

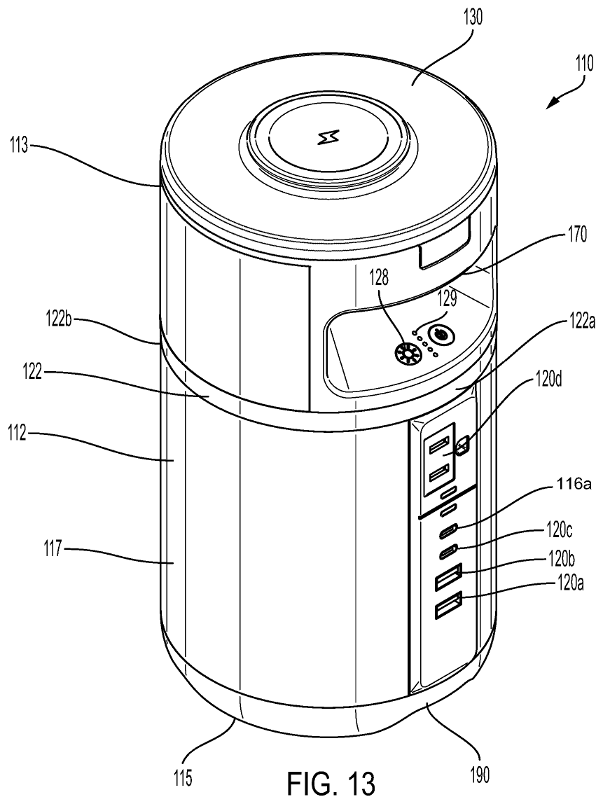

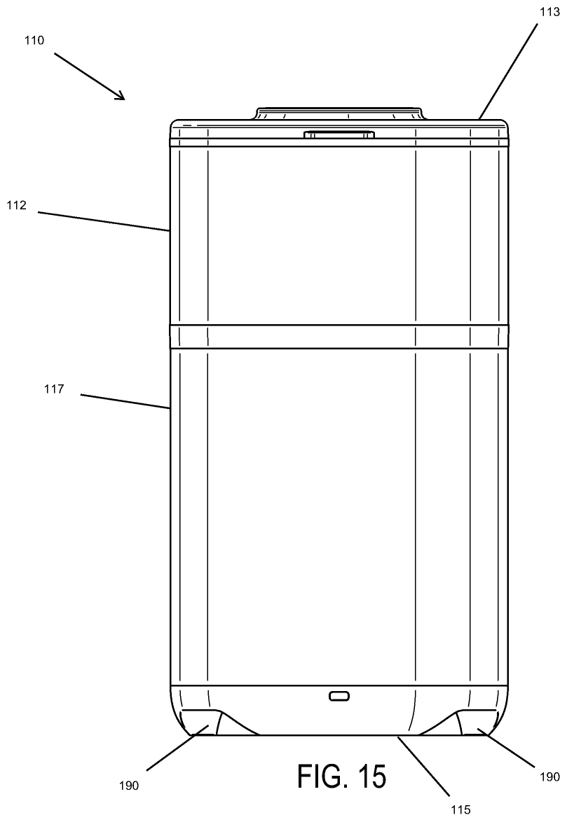

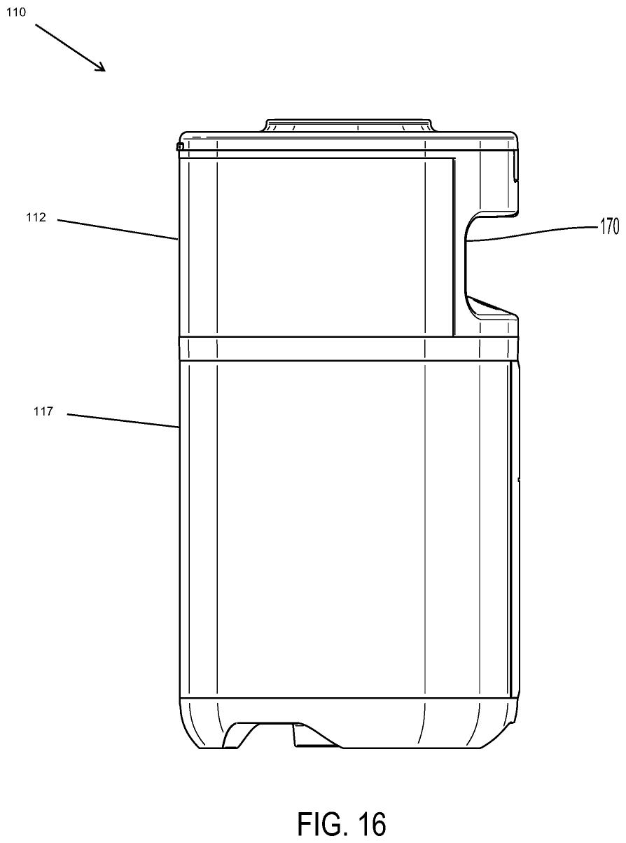

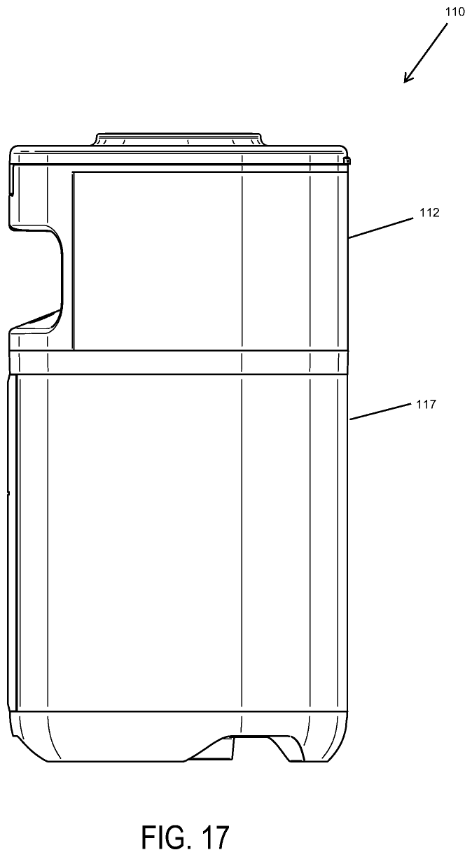

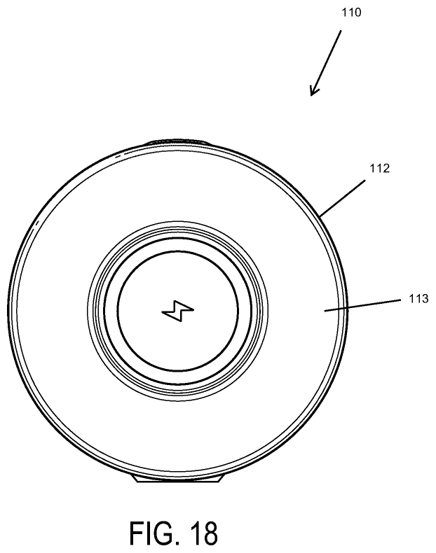

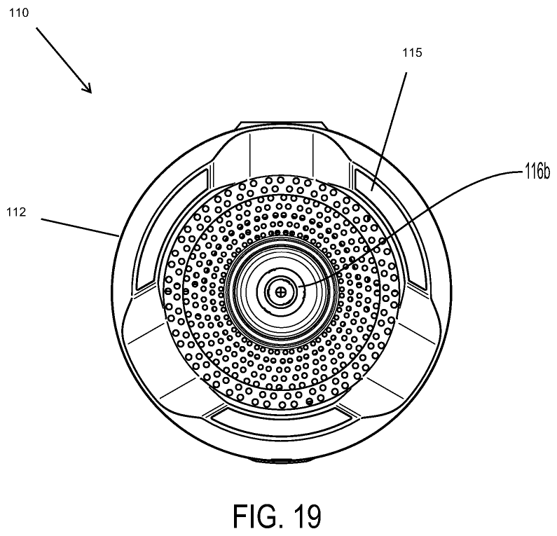

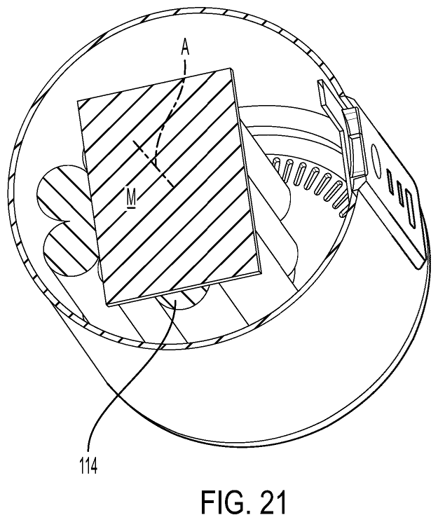

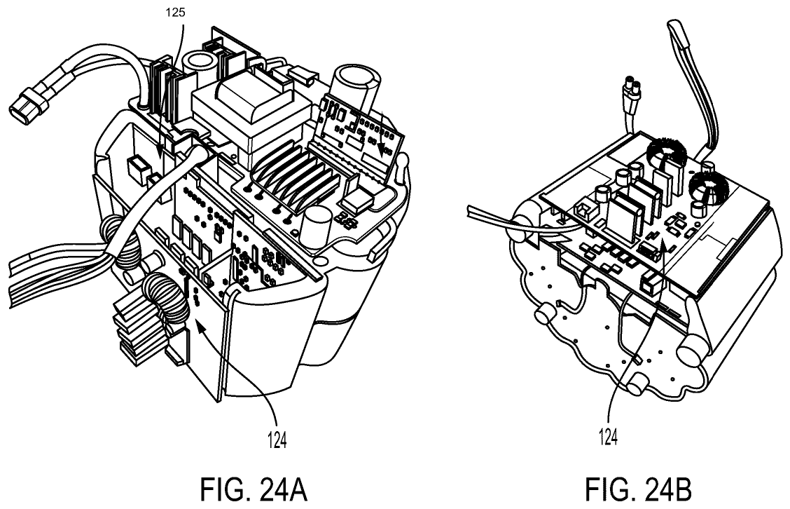

Turning now to FIGS. 13-24, a second embodiment of a portable power station 110 includes a housing 112 and a rechargeable battery 114 disposed within the housing 112. The housing 112 is cylindrical in shape (having a circular cross-sectional shape) and includes a top 113, a bottom 115, and a side wall 117. In other embodiments, the housing 112 may have other cross-sectional shapes, such as oval, oblong, square, rectangular, triangular, polygonal, or irregular.

One or more charging power ports 116a, 116b may disposed on the exterior of the housing 112. The charging power ports 116a, 116b are electrically connected to the rechargeable battery 114 and the charging power ports 116a, 116b provide an electrical current to the rechargeable battery 114 for recharging the rechargeable battery 114 of the portable power station 110. In the illustrated embodiment, a first charging power port 116a may comprise a two way power port, such as a USB-c port. The first charging power port 116a is located on the side wall 117 of the housing 112 and may accept power to charge the rechargeable battery 114 or may provide power from the rechargeable battery 114 to a device connected to the first charging power port 116a. Additionally, or alternatively, the second charging power port 116b comprises a charging port, such as an induction power port, located on the bottom 115 of the housing 112. In other embodiments, the second charging power port 116b may comprise electrical contacts that receive power from a charging base. In yet other embodiments, the charging power ports 116a, 116b may be located on another part of the housing, for example on the side wall 117 or on the top 113. In still other embodiments, the first charging power port 116a may comprise a two or three prong plug (not shown) for a power cord (not shown). Power for the charging power ports 116a, 116b may be provided by virtually any power source, such as an induction charger connected to a power grid, a DC power source connected to the charging power port 16a, 16b by a plug or wire, for example, a DC power source from a vehicle or a DC power source from a portable solar panel, or an AC source, such as a power cord connected to a residential or industrial power grid.

One or more power outlets 120a, 120b, 120c, 120d are disposed on the exterior of the housing 112. In the embodiment illustrated in FIGS. 13-24, the power outlets 120a, 120b, 120c, 120d are located on the side wall 117 of the housing 112. In other embodiments, the power outlets 120a, 120b, 120c, 120d may be located on other parts of the housing, for example, on the top 113 of the housing, as long as the power outlets 120a, 120b, 120c, 120d are accessible to a user. The power outlets 120a, 120b, 120c, 120d are electrically connected to the rechargeable battery 114. The power outlets 120a, 120b, 120c, 120d provide electrical current from the rechargeable battery 114 to a rechargeable device or electrical device (not shown), such as a cellular phone, a tablet, a laptop, a television, a light, a WiFi router, etc., that is electrically connected to the power outlet 120a, 120b, 120c, 120d for the purpose of recharging the rechargeable device or for providing electricity to the electrical device. The power outlets 120a, 120b, 120c, 120d may supply AC power or DC power. Moreover, the power outlets 120a, 120b, 120c, 120d may comprise a plug receptacle, such as a USB-C receptacle, a USB-A receptacle, or a three prong AC plug. Other types of plug receptacles may be used in other embodiments, such as a two-prong receptacle, a mini USB-B receptacle, or a micro USB-B receptacle.

An illuminating device 122, such as a ring or circumferential light, is disposed about a perimeter of the housing 112, proximate the top 113 of the housing 112. In other embodiments, the illuminating device 122 may be located proximate the bottom 115 of the housing 112. The illuminating device 122 is configured to emit light from substantially the entire perimeter of the housing 112. In some embodiments, the illuminating device 122 may comprise a plurality of discrete light emitting elements, such as light emitting diodes (LED), disposed about a perimeter of the housing 112. The plurality of LEDs may all be a single color, or the plurality of LEDs may comprise RGB LEDs to create different colors. In certain embodiments, the light emitting device 122 may emit light from substantially 360 degrees around the housing 112 (with the exception of small breaks for other elements, such as a handle). In some embodiments, the illumination device 122 may be divided into at least two segments, such as a front segment 122a and a rear segment 122b. In other embodiments, the illumination device 122 may be divided into a plurality of segments, such as 3, 4, 5, 6, or more segments. As discussed above, each segment may be independently controllable by a programmable processor 124.

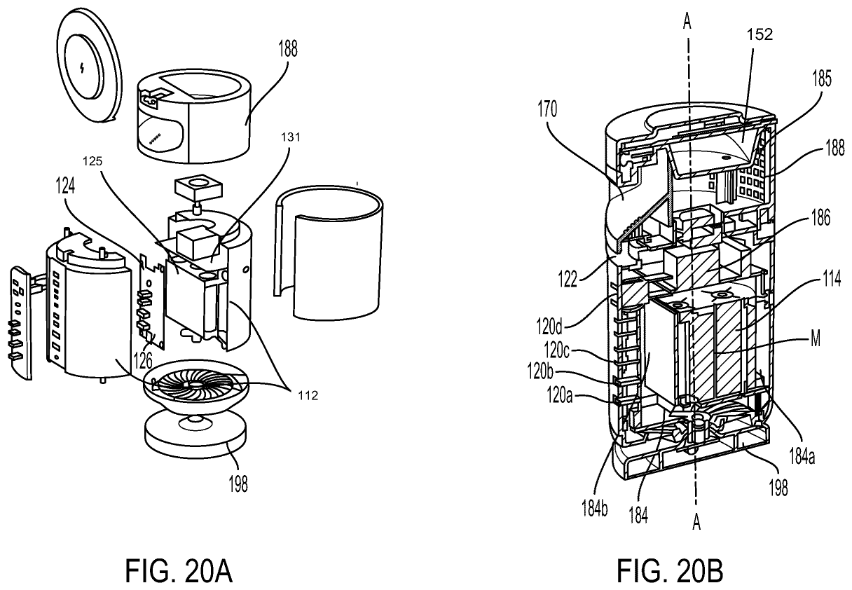

Turning now specifically to FIGS. 20A and 20B, the programmable processor 124 is disposed in the housing 112, and a wireless communication device 126 is communicatively connected to the programmable processor 124. The programmable processor 124 may also be operatively connected to a battery management system 125 and a cooling board 131. The communication device 126 may comprise an antenna and a signal receiver. The communication device 126 may be configured to connect to other devices (such as a mobile phone or a tablet computer) with Bluetooth® or WiFi signals, or any other type of wired or wireless communication protocol. The programmable processor 124 is operatively connected to the illumination device 122 and the programmable processor 124 alters a light characteristic of the illumination device 122 based on a signal received from the communication device 126. The programmable processor 124 is configured to alter a different characteristic of each segment. In some embodiments, the light characteristic is one of color, intensity, length, or duration, or combinations thereof. The programmable processor 124 alters the light characteristic based on a warning signal from the communication device 126. The warning signal may comprise one of a power grid warning (e.g., a power grid failure warning), a social alert, or a weather alert (e.g., a severe thunderstorm alert, a tornado watch, a tornado warning, a flash flood warning, a heat advisory, a hurricane watch, a hurricane warning, or any other weather related warning or notice), or combinations thereof. In other embodiments, the programmable processor 124 may be configured to alter the light characteristic based on an internal condition or an external condition, such as battery temperature (hot or cold) or battery charge capacity, overloads, low ambient light, g-loads (such as when the device is dropped), or other conditions. The programmable processor 124 may receive signals directed to such conditions from a sensor suite 127 located in the housing 112. The sensor suite 127 may include temperature sensors, acceleration sensors, glass break sensors, humidity sensors, ambient light sensors, or other sensors.

A brightness control button 128 is disposed on the exterior of the housing 112. The brightness control button 128 is operatively connected to the illumination device 122. The brightness control button 128 is configured to change a brightness level of the illumination device 122 with repeated activations of the brightness control button 128. In some embodiments, the brightness control button 128 converts to an on/off button for the illumination device 122 if a minimum period of time passes between activations of the brightness control button 128. For example, the brightness control button 128 may convert to an on/off button if a minimum period of time is greater than or equal to 5 seconds. In other embodiments, the minimum period of time may be between 1 second and 30 seconds, between 5 seconds and 20 seconds, or between 10 seconds and 20 seconds. A series of indicator lights 129 may be disposed on the housing 112. The indicator lights 129 may indicate the intensity of the illumination device 122. For example, one indicator light may indicate 20% intensity. Other indicator lights 129 may indicate increasing intensity, for example, in 20% increments. In other embodiments, more or fewer indicator lights 129 may be included, which indicate greater or less than 20% increments.

A tiltable magnetic charging lid 130 is pivotably connected to the housing 112, proximate the top 113 of the housing 112. The tiltable magnetic charging lid 130 of the embodiment of FIGS. 13-24 has the same elements as the tiltable magnetic charging lid 130 of the embodiment of FIGS. 1-12, thus the description of the tiltable magnetic charging lid 130 is omitted for the embodiment of FIGS. 13-24 for the sake of brevity.

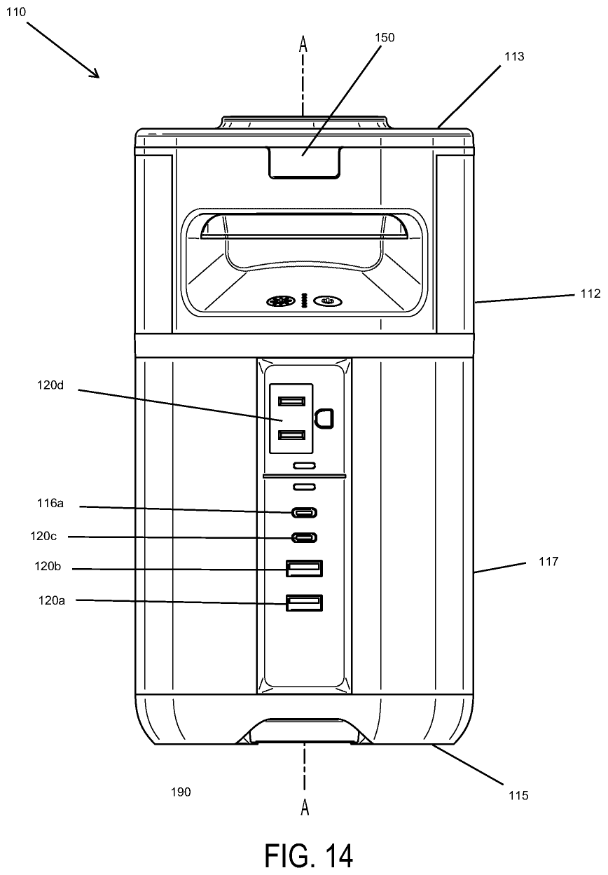

The power outlets 120a, 120b, 120c, 120d are disposed on a front portion of the housing 112. The housing 112 includes a longitudinal axis A (see FIGS. 14, 20B, and 23), the longitudinal axis A being located between a center of mass M of the rechargeable battery 114 and the power outlets 120a, 120b, 120c, 120d.

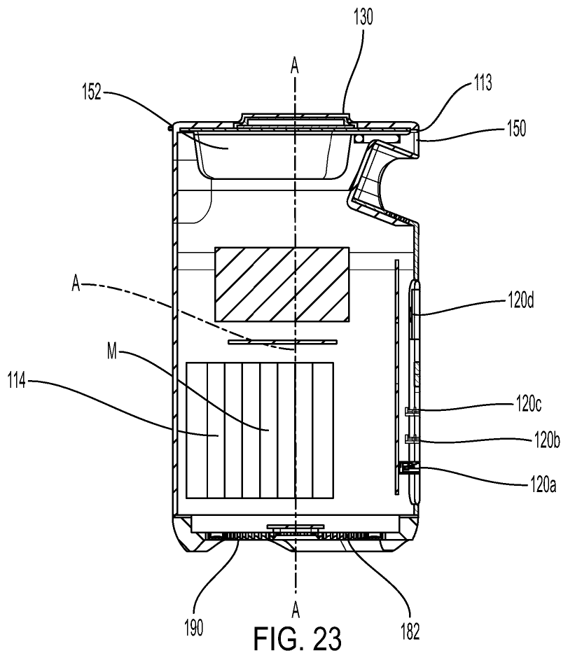

The tiltable magnetic charging lid 130 is pivotably attached to the housing 112 with a hinge 150 (FIG. 23). The hinge 150 is attached to the housing 112 at a front portion of the housing 112, proximate the power outlets 120a, 120b, 120c, such that the longitudinal axis A is disposed between the hinge 150 and the center of mass M of the rechargeable battery 114.

A recessed storage compartment 152 (FIGS. 20B and 23) is disposed in the top 113 of the housing 112. The recessed storage compartment 152 is recessed relative to the top 113 of the housing 112. The recessed storage compartment 152 is adapted to store small items, such as charging cords, ear buds, wallets, jewelry, etc. The tiltable magnetic charging lid 130 covers the recessed storage compartment 152 when the tiltable magnetic charging lid 130 is in a closed position (FIGS. 13-18, 20B, and 23). The tiltable magnetic charging lid 130 exposes at least a part of the recessed storage compartment 152 when the tiltable magnetic charging lid 130 is not in the closed position.

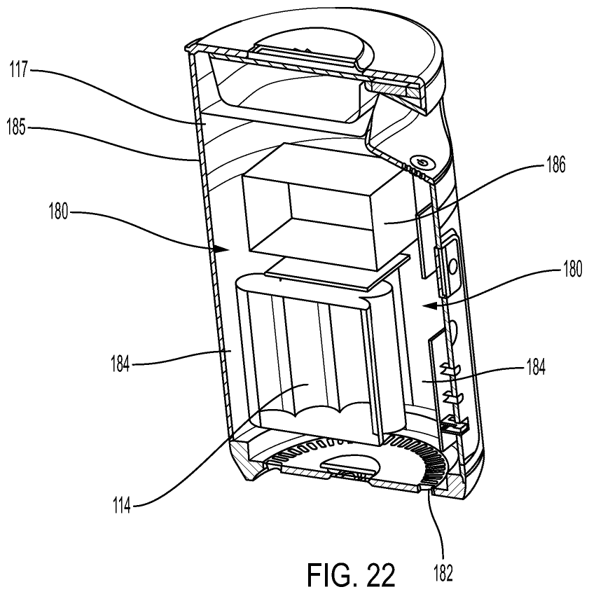

The housing 112 includes a cooling channel 180 (FIG. 22) for cooling internal components, such as the rechargeable battery 114, the programmable processor 124 and the communication device 126. The cooling channel 180 is formed by an air inlet 182 formed in the bottom of the housing 112, a cooling conduit 184 that extends along a length of the housing 112, inside the housing sidewall 117, and an air outlet 185, proximate the top 113 of the housing 112.

The cooling conduit 184 may comprise two or more cooling branches 184a, 184b (FIG. 20B). A first cooling branch 184a passes around parts of the rechargeable battery 114 to cool the rechargeable battery 114. A second cooling branch 184b bypasses the rechargeable battery 114 and extends upward to pass around the programmable processor 124 and other electronics. By separating the electronics from the rechargeable battery 114, heat from the rechargeable battery 114 is not transferred to the electronics, which could cause electronic overheating. A fan 186 is located within the cooling conduit 184, generally above the rechargeable battery 114 and the electronic components, such as the programmable processor 124.

A fan 186 is located within the cooling conduit 184. The fan 186 is a variable speed fan that is operatively connected to the programmable processor 124. The fan 186 aids in moving air through the cooling conduit 184 when extra cooling capacity is needed. The air inlet 182 being located in the bottom 115 of the housing 112 and the air outlet 185 being located proximate the top 113 of the housing creates a convective airflow due to the rising hot air inside the housing 112. The convective airflow reduces the need for the fan 186 to augment the cooling airflow through the cooling conduit 184. As a result, a smaller fan may be used. A metal mesh 188 covers the air outlet 185 of the cooling conduit 182. In some embodiments, the openings in the metal mesh 188 may be designed to enhance airflow out of the air outlet 185, thereby increasing cooling airflow through the cooling conduit 184.

The portable power station 110 is normally placed in an upright position on a flat surface, such as a charging plate 198, or other flat surface such as a table, a desk, or the ground. A plurality of raised channels 190 is disposed in the bottom 115 of the housing 112. The raised channels 190 are configured to allow air to flow radially inward along the bottom 115 of the housing 112 when the housing 112 is resting on a flat surface so that air can enter the air inlet 182.

A handle 170 is formed in a front of the housing 112. In the illustrated embodiment, the handle 170 is located proximate the top 113 of the housing 112. The handle provides both a grip for a user and a recessed area for some of the controls and indicators, such as the brightness control button 128 and the indicator lights 129, thereby providing some protection from accidental activation and/or damage from environmental factors or impacts.

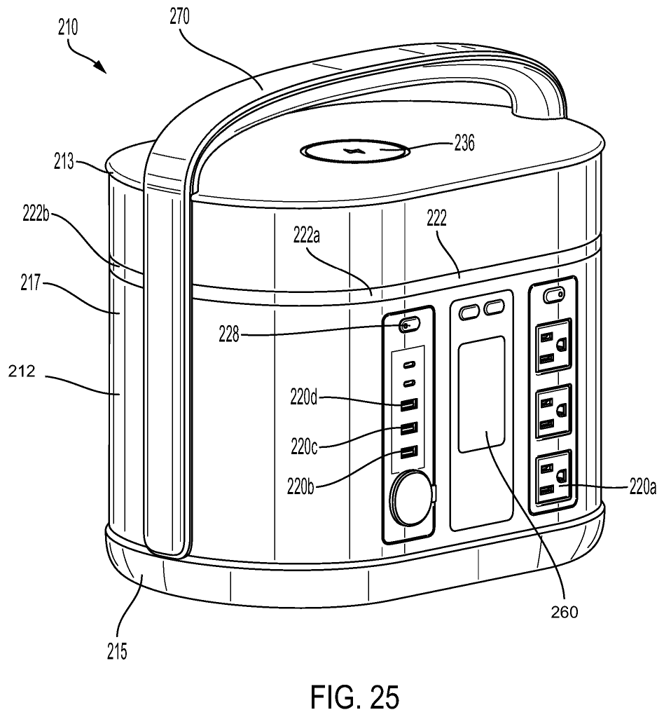

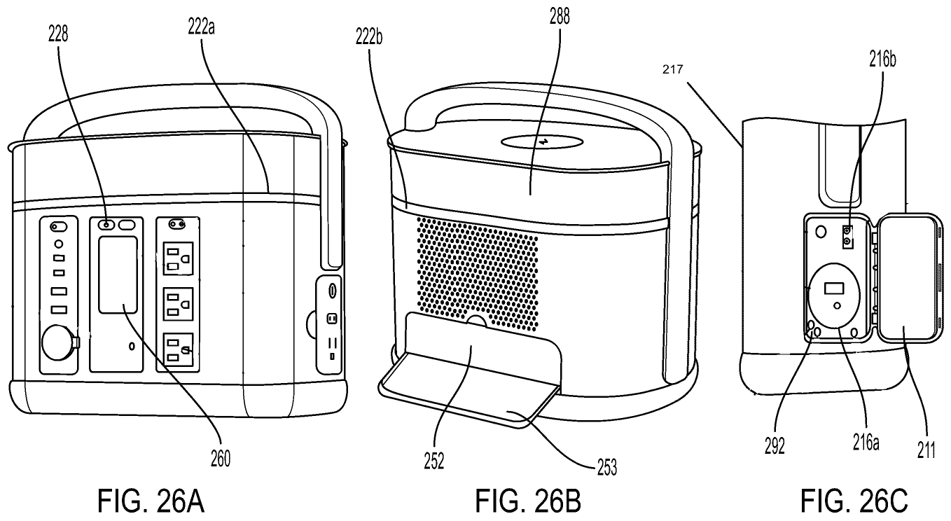

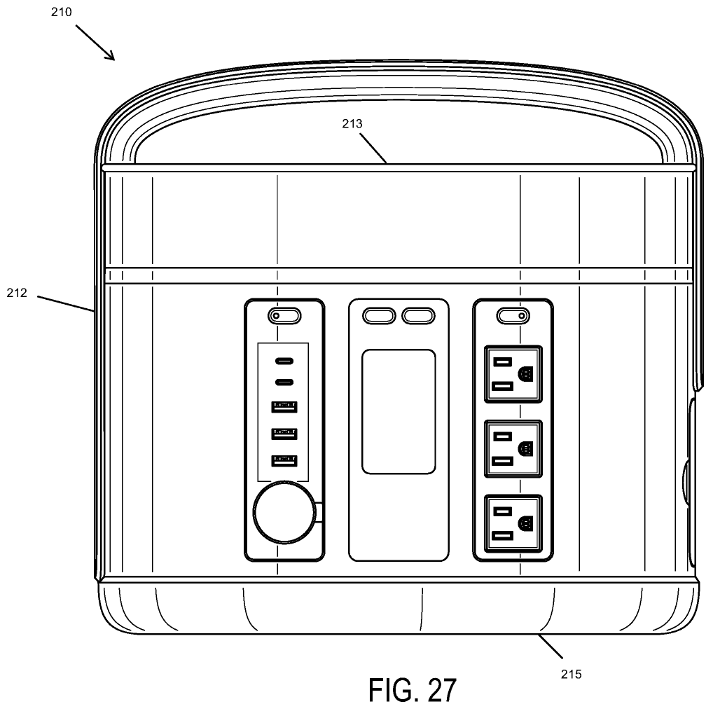

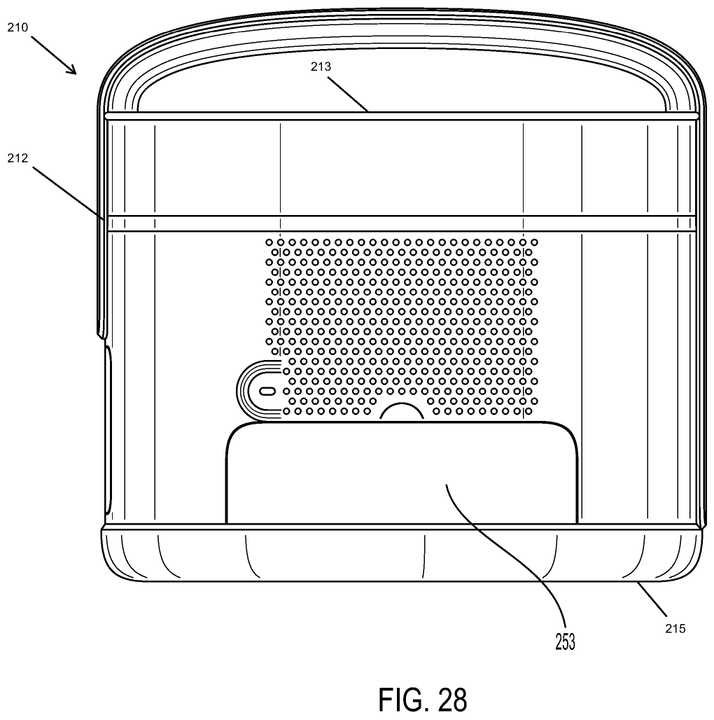

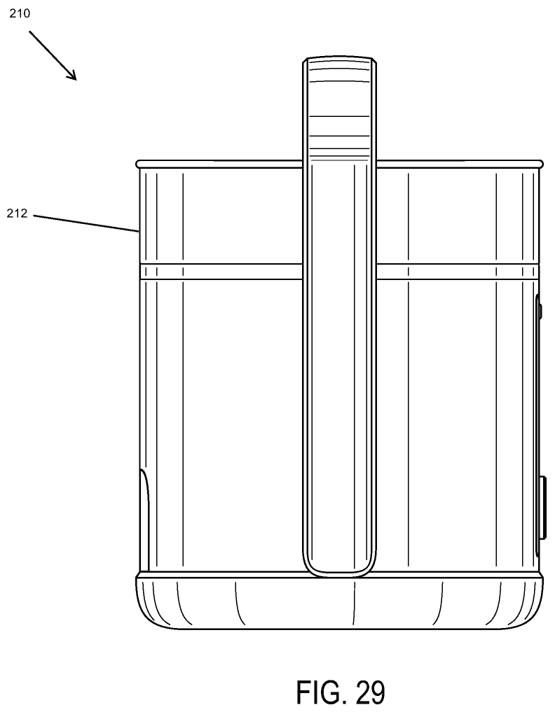

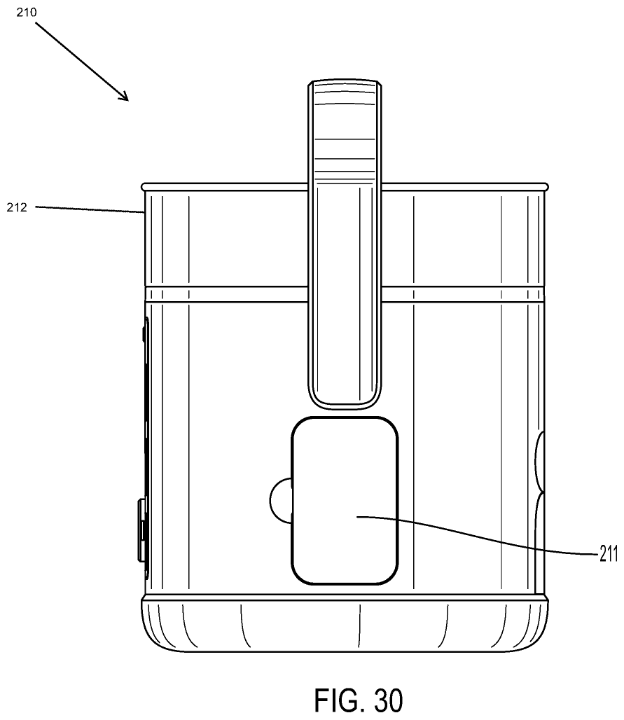

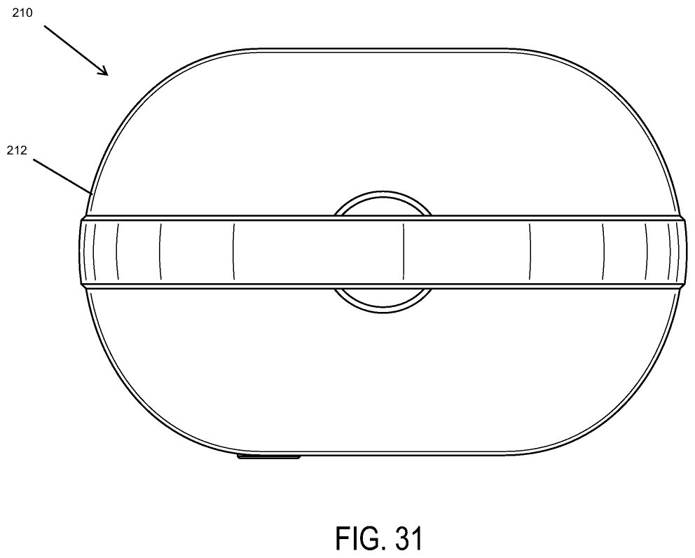

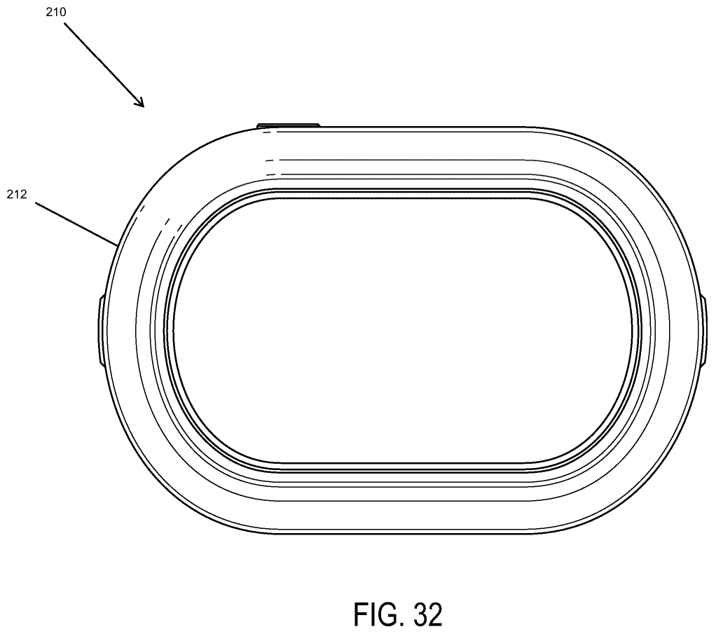

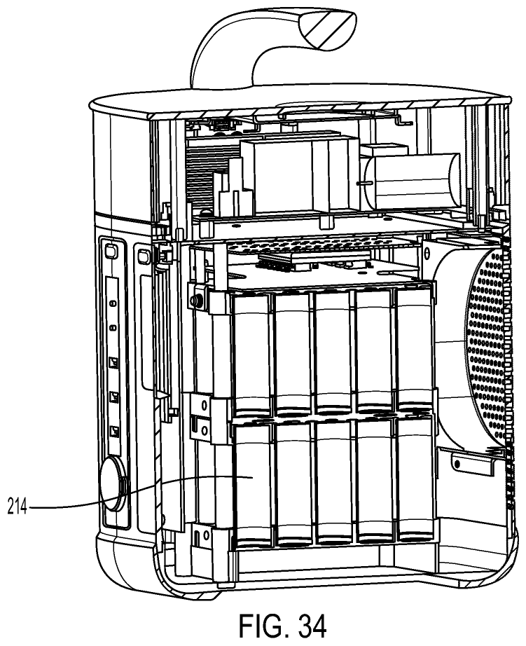

Turning now to FIGS. 25-34, a third embodiment of a portable power station 210 includes a housing 212 and a rechargeable battery 214 disposed within the housing 212. The housing 212 is generally cylindrical in shape (having an oval or rectangular with rounded corners cross-sectional shape) and includes a top 213, a bottom 215, and a side wall 217. In other embodiments, the housing 212 may have other cross-sectional shapes, such as oval, oblong, square, rectangular, triangular, polygonal, or irregular. A charging power port 216a, 216b (FIG. 26C) is disposed on the exterior of the housing 212. A first charging port may comprise an AC plug 216a, and a second charging port may comprise a DC plug 216b. The charging power port 216a, 216b is electrically connected to the rechargeable battery 214 and the charging power port 216a, 216b provides an electrical current to the rechargeable battery 214 for recharging the rechargeable battery 214. In the illustrated embodiment, the charging power port 216a, 216b is a power receptacle on the sidewall 217 of the housing 212, behind a door 211 on the right hand side of the housing 212. In other embodiments, the charging power port 216 may be located on another part of the housing 212, for example on the bottom 115 or on the top 113. In other embodiments, the charging power port 216a, 216b may comprise a charging cord and plug (not shown) or an induction charger (not shown).

The DC plug 216b includes a current limiter that limits current based on input voltage to protect a charging circuit, such as a car charging circuit. In one embodiment, the current limiter limits current to less than 10 A when the input voltage is below 16 VDC, for example when charging from a car charger to prevent blowing a fuse for the car charger. The current limiter may limit current to between about 20 A and about 30 A when the input voltage is greater than 16 VDC, for example when charging from a portable solar panel. In other embodiments, the current limiter may vary the current limit to different values in the charging cycle.

One or more power outlets 220a, 220b, 220c, 220d are disposed on the exterior of the housing 212. The power outlets 220a, 220b, 220c, 220d are electrically connected to the rechargeable battery 214. The power outlets 220a, 220b, 220c, 220d provide electrical current from the rechargeable battery 214 to a rechargeable device or electrical device (not shown), such as a cellular phone, a tablet, a laptop, a television, a light, a WiFi router, etc., that is electrically connected to the power outlet 220a, 220b, 220c, 220d for the purpose of recharging the rechargeable device or for providing electricity to the electrical device. The power outlets 220a, 220b, 220c, 220d may supply AC power or DC power. Moreover, the power outlets 220a, 220b, 220c, 220d may comprise a plug receptacle, such as a USB-C receptacle or a USB-A receptacle. Other types of plug receptacles may be used in other embodiments, such as a three-prong receptacle, a two-prong receptacle, a mini USB-B receptacle, or a micro USB-B receptacle. The top 213 of the housing 212 may include an induction charging interface 236, as described in the embodiments of FIGS. 1-24 above.

An illuminating device 222, such as a circumferential light, is disposed about a perimeter of the housing 212, proximate the top 213 of the housing 212. The illuminating device 222 is configured to emit light from substantially the entire perimeter of the housing 212. In some embodiments, the illuminating device 222 may comprise a plurality of discrete light emitting elements, such as light emitting diodes (LED), disposed about a perimeter of the housing 212. The plurality of LEDs may all be a single color, or the plurality of LEDs may comprise RGB LEDs to create different colors. In certain embodiments, the light emitting device 222 may emit light from substantially 360 degrees around the housing 212 (with the exception of small breaks for other elements, such as a handle). In some embodiments, the illumination device 222 may be divided into at least two segments, such as a front segment 222a and a rear segment 222b. In other embodiments, the illumination device 222 may be divided into a plurality of segments, such as 3, 4, 5, 6, or more segments. The front segment 222a and the rear segment 222b may be independently controllable by a programmable processor 224.

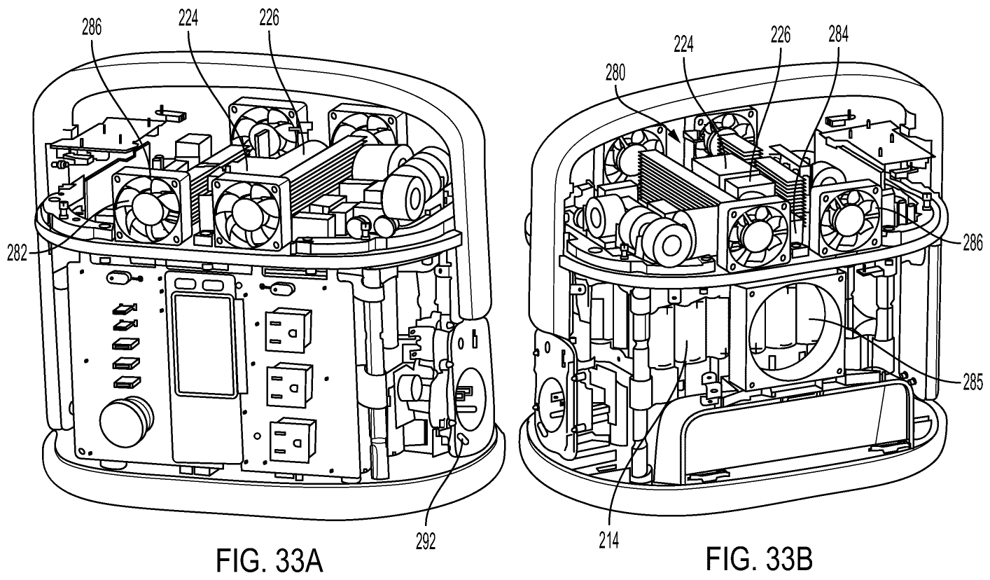

Turning now specifically to FIGS. 33A and 33B, the programmable processor 224 is disposed in the housing 212, and a wireless communication device 226 is communicatively connected to the programmable processor 224. The communication device 226 may comprise an antenna and a signal receiver. The programmable processor 224 is operatively connected to the illumination device 222 and the programmable processor 224 alters a light characteristic of the illumination device 222 based on a signal received from the communication device 226. The programmable processor 224 is configured to alter a different characteristic of each segment. In some embodiments, the light characteristic is one of color, intensity, length, or duration, or combinations thereof. The programmable processor 224 alters the light characteristic based on a warning signal from the communication device 226. The warning signal may comprise one of a power grid warning, a social alert, or a weather alert, or combinations thereof. In other embodiments, the programmable processor may be configured to alter the light characteristic based on an internal condition, such as battery temperature (hot or cold) or battery charge capacity.

The housing 212 includes a cooling channel 280 for cooling internal components, such as the rechargeable battery 214, the programmable processor 224 and the communication device 226. The cooling channel 280 is formed by an air inlet 282 formed in the top of the housing 212, a cooling conduit 284 that extends through the housing 212, from one side of the housing 212 to the other side of the housing 212, and an air outlet 285, proximate located in the back of the housing 212. The cooling conduit 284 passes around the rechargeable battery 214 and around internal electronic components, such as the programmable processor 224 and the communication device 226. One or more fans 286 are located within the cooling conduit 284. The fans 286 are variable speed fans that are operatively connected to the programmable processor 224. The fans 286 aid in moving air through the cooling conduit 284 when extra cooling capacity is needed. The air inlet 282 being is covered by a metal mesh 288. In some embodiments, the openings in the metal mesh 288 may be designed to enhance airflow into the air inlet 282, thereby increasing cooling airflow through the cooling conduit 284. In some embodiments, the metal mesh may comprise between 10% and 50% of the height of the housing 212, preferably between 20% and 40% of the height of the housing.

A brightness control button 228 is disposed on the exterior of the housing 212. The brightness control button 228 is operatively connected to the illumination device 222. The brightness control button 228 is configured to change a brightness level of the illumination device 222 with repeated activations of the brightness control button 228. In some embodiments, the brightness control button 228 converts to an on/off button for the illumination device 222 if a minimum period of time passes between activations of the brightness control button 228. For example, the brightness control button 228 may convert to an on/off button if a minimum period of time is greater than or equal to 5 seconds. In some embodiments, the brightness control may be programmed through an application on a mobile device that is communicatively connected to the communication device 226. In other embodiments, the minimum period of time may be between 1 second and 30 seconds, between 5 seconds and 20 seconds, or between 10 seconds and 20 seconds. A series of brightness indicators may be located in a user interface or display screen 260 on the front of the housing 212. The brightness indicators may indicate the intensity of the illumination device 222. For example, one indicator may indicate 20% intensity. Other indicators may indicate increasing intensity, for example, in 20% increments. In other embodiments, more or fewer indicators may be included, which indicate greater or less than 20% increments.

A fast charge switch 292 is operatively connected to the power outlets 220a, 220b, 220c, 220d and to a variable speed fan 286. The power outlets 220a, 220b 220c, 220d are configured to charge at a rate of 0.25-0.75 Coulomb (C) as a default rate. The fast charge switch 292 is configured to change the power output of the power outlets 220a, 220b, 220c, 220d to a fast charge level (above 0.75 C) and the fast charge switch 292 also operates the fan 286 when the power outlets 220a, 220b, 220c, 220d are changed to the fast charge level to augment cooling airflow through a cooling conduit, which is needed to remove extra internal heat created by the fast charge level. The fast charge switch 292 operates the power outlets 220a, 220b, 220c, 220d at the fast charge level for a period of time, or until a device being charged reaches a full charge state, and, thereafter, the power outlets 220a, 220b, 220c, 220d return to a normal charge level and the variable speed fan 286 is turned off. In this manner, the fast charge switch 292 only uses the fast charge level when needed by a user, which reduces fan 286 run time and noise created by the fan 286.

A current limiter is operatively connected to a DC input. The current limiter limits charging current to the rechargeable battery 214 based an input voltage. For example, the current limiter may limit current when the input current to less than 10 A when the input voltage is below approximately 16 VDC, which may occur when charging the rechargeable battery from a car power port. This reduction in charging current advantageously reduces the chance of blowing a car circuit breaker for the car power port. The current limiter may limit charging current to between about 20 A and about 30 A when the input voltage is above 16 VDC, for example, when charging the rechargeable battery from a portable solar power panel.

The user interface or display screen 260 is disposed on the exterior of the housing 212.

A handle 270 is formed in a front of the housing 212. In the illustrated embodiment, the handle 270 is located proximate the top 213 of the housing 212.

In some embodiments, an integrated storage space 252 may be located behind a door 253 on a rear of the housing 212. In other embodiments, the integrated storage space 252 may be located on other parts of the housing 212.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A portable power station comprising:
a housing;
a rechargeable battery disposed within the housing;
a charging power port disposed on the exterior of the housing, the charging power port being electrically connected to the rechargeable battery, the charging power port being adapted for providing an electrical current to the rechargeable battery for recharging the rechargeable battery;
a power outlet disposed on the exterior of the housing, the power outlet being electrically connected to the rechargeable battery, the power outlet being adapted for providing electrical current from the battery to a rechargeable device electrically connected to the power outlet; and
an illuminating device disposed about a perimeter of the housing, proximate a top of the housing, the illuminating device being configured to emit light from at least 180 degrees about the perimeter of the housing.

2-16. (canceled)

17. A portable power station comprising:
a housing;
a rechargeable battery disposed within the housing;
a charging power port disposed on the exterior of the housing, the charging port being electrically connected to the rechargeable battery, the charging power port being adapted for providing an electrical current to the rechargeable battery for recharging the rechargeable battery;
a power outlet disposed on the exterior of the housing, the power outlet being electrically connected to the rechargeable battery, the power outlet being adapted for providing electrical current from the battery to a rechargeable device electrically connected to the power outlet; and
a tiltable magnetic charging lid pivotably connected to the housing, proximate a top of the housing, the tiltable magnetic charging lid comprising a wireless induction charging coil, a magnet, and a charging interface formed by a top surface of the tiltable magnetic charging lid, the tiltable magnetic charging lid tilting from zero to greater than 70 degrees, preferably up to at least 120 degrees relative to the top of the housing.

18. The portable power station of claim 17, wherein the magnet is disposed in an opening in the tiltable magnetic charging lid.

19. The portable power station of claim 18, wherein the tiltable magnetic charging lid further comprises a thin plastic cover that is the only separation between the magnet and the charging interface.

20. (canceled)

21. The portable power station of claim 19, wherein the tiltable magnetic charging lid comprises a top surface having a central raised platform.

22. The portable power station of claim 18, wherein the opening is annular in shape and the opening is located at least partially in the central raised platform.

23. The portable power station of claim 18, wherein the magnet and plastic cover form a raised annular ring on the central raised platform that extends outward from a top surface of the lid.

24. The portable power station of claim 23, wherein the lid comprises a recessed annular portion outward of the central raised platform, the recessed annular portion being recessed relative to the central raised platform and the recessed annular portion at least partially surrounds the magnet and plastic cover.

25. The portable power station of claim 17, further comprising a recessed storage compartment disposed in a top of the housing, the recessed storage compartment being recessed relative to the top of the housing, the tiltable magnetic charging lid covering the recessed storage compartment when the tiltable magnetic charging lid is in a closed position, and the tiltable magnetic charging lid exposing at least a part of the recessed storage compartment when the tiltable magnetic charging lid is not in the closed position.

26. The portable power station of claim 17, wherein the power outlet is disposed on a front portion of the housing, and the housing includes a longitudinal axis, the longitudinal axis being located between the rechargeable battery and the power outlet.

27. The portable power station of claim 26, wherein the tiltable magnetic charging lid is pivotably attached to the housing with a hinge, and the hinge is attached to the housing in at a front portion of the housing, such that the longitudinal axis is disposed between the hinge and the rechargeable battery.

28. A portable power station comprising:
a housing;
a rechargeable battery disposed within the housing;
a charging power port disposed on the exterior of the housing, the charging port being electrically connected to the rechargeable battery, the charging power port being adapted for providing an electrical current to the rechargeable battery for recharging the rechargeable battery;
a power outlet disposed on the exterior of the housing, the power outlet being electrically connected to the rechargeable battery, the power outlet being adapted for providing electrical current from the battery to a rechargeable device electrically connected to the power outlet; and
a cooling air flow conduit, the cooling airflow conduit having an inlet in a bottom of the housing and an outlet proximate a top of the housing.

29-36. (canceled)

37. A portable power station comprising:
a housing;
a rechargeable battery disposed within the housing;
a charging power port disposed on the exterior of the housing, the charging port being electrically connected to the rechargeable battery, the charging power port being adapted for providing an electrical current to the rechargeable battery for recharging the rechargeable battery;
a power outlet disposed on the exterior of the housing, the power outlet being electrically connected to the rechargeable battery, the power outlet being adapted for providing electrical current from the battery to a rechargeable device electrically connected to the power outlet;
a tiltable magnetic charging lid pivotably connected to the housing, proximate a top of the housing, the tiltable magnetic charging lid comprising a wireless induction charging coil, a magnet, and a charging interface formed by a top surface of the tiltable magnetic charging lid; and
a speaker and a microphone operatively attached to the housing, the speaker and the microphone being communicatively connected to a programmable processor and a communication device.

38. The portable power station of claim 37, wherein the charging port is disposed on the bottom of the housing.

39. (canceled)

40. The portable power station of claim 37, wherein the charging port is a first charging port disposed on the bottom of the housing, and further comprising a second charging port disposed on a side wall of the housing.

41. The portable power station of claim 37, wherein the charging port is disposed on the bottom of the housing and the charging port is omnidirectional and is adapted to contact electrical contacts of a charging base regardless of rotational orientation between the portable power station and the charging base.

42. The portable power station of claim 1, wherein the power outlet comprises a tiltable magnetic charging lid

43. The portable power station of claim 17, wherein the charging power port comprises a circular recessed port on a bottom of the housing.

44. The portable power station of claim 43, wherein the circular recessed port comprises an inverted cone.

45. The portable power station of claim 17, wherein the charging power port is omnidirectional.
